(19) United States
(12) Patent Application Publication
(10) Pub. No.: US 2021/0279579 A1
(43) Pub. Date: Sep. 9, 2021

(54) CONVERSION APPARATUS, LEARNING APPARATUS, CONVERSION METHOD, LEARNING METHOD AND PROGRAM

(71) Applicant: NIPPON TELEGRAPH AND TELEPHONE CORPORATION, Tokyo (JP)

(72) Inventors: Mathieu BLONDEL, Musashino-shi, Tokyo (JP); Mensch ARTHUR, Paris (FR)

(21) Appl. No.: 17/258,236

(22) PCT Filed: Jun. 27, 2019
(86) PCT No.: PCT/JP2019/025636

§ 371 Date: Jan. 6, 2021

(30) Foreign Application Priority Data
Jul. 9, 2018 (JP) 2018-129998

(51) Int. Cl. G06N 3/08; G06K 9/62; G06F 17/17

(52) U.S. Cl. CPC G06N 3/08; G06F 17/17; G06K 9/6296

(57) ABSTRACT

A conversion device of the present invention converts input first data X into second data Y using a neural network. The conversion device includes: calculating means for calculating an approximation DP_{Ω}(θ) of a solution of dynamic programming that addresses a problem expressed by a weighted directed acyclic graph G, with use of third data θ obtained by predetermined preprocessing performed on the first data X, and with use of a DP_{Ω} function recursively defined using a max_{Ω} function in which a strongly-convex regularization function Ω is implemented in a max function; and outputting means for outputting, as the second data Y, at least one of DP_{Ω}(θ) calculated by the calculating means and a gradient ∇DP_{Ω}(θ) of DP_{Ω}(θ).

### TECHNICAL FIELD

The present invention relates to a conversion device, a training device, a conversion method, a training method, and a program.

### BACKGROUND ART

A type of mathematical model called a neural network is conventionally known. A classical neural network performs calculation for converting input data expressed by a vector into output data expressed by a vector, a scalar, or the like. Calculation in this type of neural network can be described in the format of nested functions that express layers.

In recent years, neural networks have come to be applied in various fields, and neural networks are often used to handle complex problems. When such a complex problem is handled using a neural network, it is often the case that the input data and the output data are data that is structured (hereinafter, also called “structured data”). Here, structured data is not simple vector data or the like, but rather is data that has some sort of structure, examples of which include data whose elements have a structured relationship with each other, and data that has a structured relationship with other data. Specific examples of structured data include a word sequence that makes up a text document, and a vector or matrix that expresses a correspondence relationship between pieces of time-series data.

In order to handle such structured data with a neural network, a method is known in which dynamic programming computation is used as a neural network layer. Dynamic programing computation is a technique in which a target problem is recursively broken down into sub-problems, and the sub-problems are successively solved in order to obtain a solution. Note that due to the versatility of expressive power of dynamic programming computation, such computation is often non-differentiable.

When parameters in a neural network are trained through back propagation for example, the derivative of a predetermined loss function is calculated based on prediction output of the neural network and correct answer data. The computation performed in the layers of the neural network thus needs to be differentiable.

However, because dynamic programming computation is often non-differentiable computation, parameter training is sometimes difficult in a neural network that has dynamic programming layers. To address this, methods have been proposed in which a CRF (Conditional Random Field) is used to convert dynamic programming computation into differentiable computation (e.g., NPL 1 and NPL 2).

### CITATION LIST

### [Non Patent Literature]

[NPL 1] Lample, Guillaume, Ballesteros, Miguel, Subramanian, Sandeep, Kawakami, Kazuya, and Dyer, Chris. Neural architectures for named entity recognition. In Proc. of NAACL, pp. 260-270, 2016.
[NPL 2] Cuturi, Marco and Blondel, Mathieu. Soft-DTW: a Differentiable Loss Function for Time-Series. In Proc. of ICML, pp. 894-903, 2017.

### SUMMARY OF THE INVENTION

### Technical Problem

However, with the methods proposed in NPL 1 and NPL 2, the output data of the dynamic programming computation layer loses sparsity, and therefore the interpretability of the output data has sometimes decreased.

In the case of a problem addressed by dynamic programming, interpretability between the structured data that is input (hereinafter, also called “structured input data”) and the structured data that is output (hereinafter, also called “structured output data”) is often very important. For example, in the case where the structured input data is a word sequence that makes up a text document and the structured output data is a matrix indicating the tagging of words in the word sequence (e.g., tags indicating the parts of speech or categories of words), it is often preferable to obtain structured output data in which one tag is associated with each word. However, with the methods proposed in NPL 1 and NPL 2, the output data of the dynamic programming computation layer loses sparsity, and therefore sometimes the structured output data is data in which multiple tags are associated with a word. For this reason, it is sometimes difficult to make an interpretation such as specifying one part of speech for a certain word.

An embodiment of the present invention was achieved in light of the foregoing situation, and an object thereof is to realize dynamic programming computation that is differentiable and has high interpretability.

### Means for Solving the Problem

In order to achieve the aforementioned object, an embodiment of the present invention is a conversion device that converts input first data X into second data Y using a neural network, the conversion device including: calculating means for calculating an approximation DP_{Ω}(θ) of a solution of dynamic programming that addresses a problem expressed by a weighted directed acyclic graph G, with use of third data θ obtained by predetermined preprocessing performed on the first data X, and with use of a DP_{Ω} function recursively defined using a max_{Ω} function in which a strongly-convex regularization function Ω is implemented in a max function; and outputting means for outputting, as the second data Y, at least one of DP_{Ω}(θ) calculated by the calculating means and a gradient ∇DP_{Ω}(θ) of DP_{Ω}(θ).

### Effects of the Invention

According to this embodiment of the present invention, it is possible to realize dynamic programming computation that is differentiable and has high interpretability.

### BRIEF DESCRIPTION OF DRAWINGS

FIG. 1 is a diagram showing an example of a function configuration of a conversion device in an embodiment of the present invention.

FIG. 2 is a diagram showing an example of a function configuration of a training device in an embodiment of the present invention.

FIG. 3 is a diagram showing an example of a directed acyclic graph in the case of realizing a Viterbi algorithm

FIG. 4 is a diagram showing an example of a directed acyclic graph in the case of realizing dynamic time warping.

FIG. 5 is a diagram showing an example of effects of the present invention.

FIG. 6 is a diagram showing an example of a hardware configuration of the conversion device and the training device according to embodiments of the present invention.

### DESCRIPTION OF EMBODIMENTS

Embodiments of the present invention are described below. The following describes a conversion device 100 that converts structured input data into structured output data, as an embodiment of the present invention. Here, the conversion device 100 of this embodiment of the present invention uses differentiable dynamic programming computation to convert structured input data into structured output data that has high interpretability. The dynamic programming computation executed by the conversion device 100 of this embodiment of the present invention is realized as a neural network layer.

Also, a training device 200 that trains a neural network including a layer realized by the aforementioned dynamic programming computation will also be described as an embodiment of the present invention.

Here, part-of-speech tagging is one example of a task in which structured input data is converted into structured output data. In part-of-speech tagging, the structured input data is a word sequence that makes up a text document, and the structured output data is a matrix that indicates the tagging of words included in the word sequence (e.g., tags indicating the parts of speech of the words), for example. In this case, the conversion device 100 of this embodiment of the present invention functions as a text analysis device.

Translation is another example of a task in which structured input data is converted into structured output data. In translation, the structured input data is a word sequence that makes up a text document in the source language, and the structured output data is a word sequence obtained by translating the word sequence into the target language, for example. In this case, the conversion device 100 of this embodiment of the present invention functions as a translation device.

The alignment of pieces of time-series data is another example of a task in which structured input data is converted into structured output data. In this alignment, the structured input data is data indicating pieces of time-series data, and the structured output data is a vector, a matrix, or the like expressing a correspondence relationship between the pieces of time-series data (e.g., the similarity between elements included in the pieces of time-series data), for example. In this case, the conversion device 100 of this embodiment of the present invention functions as a time-series data alignment device.

Note that the structured input data is not limited to the above-described word sequence or pieces of time-series data. Any data expressed by a series, a sequence, or the like can be used as the structured input data. For example, the structured input data can be image data, video data, data expressing an acoustic signal, data expressing a biological signal, or the like.

### Theoretical Background

The following describes the theoretical background of conversion, training, and the like executed with use of dynamic programming by the conversion device 100 and the training device 200 of embodiments of the present invention. In the following embodiments of the present invention, the structured input data is denoted by X, and the structured output data is denoted by Y. Also, a set of structured output data X will be denoted as follows.

x [Formula 1]

Also, a set of structured output data Y will be denoted as follows.

y [Formula 2]

When performing some sort of task for converting the structured input data X into the structured output data Y, the procedures shown in Expressions 1 and 2 below for example are performed.

$$\begin{matrix}[ Formula 3 ] & \\ X ∈ x {\to }_{preprocessing} θ ∈ Θ {\to }_{DP} value ∈ R \to … & ( 1 ) \\ [ Formula 4 ] & \\ X ∈ x {\to }_{preprocessing} θ ∈ Θ {\to }_{DP + backtracking} {Y}^{*} ∈ y \to … & ( 2 )\end{matrix}$$

Here, θ is a matrix or a tensor having real numbers as elements, and θ is a set of θ. Also, the bold R indicates all real numbers. For the sake of convenience in the notation used in this specification, all real numbers will hereinafter also be simply denoted as “R”.

Also, “preprocessing” is for converting (projecting) the structured input data X into θ in accordance with the problem addressed by dynamic programming, and is realized by a neural network, for example. Specifically, in the case of a problem that involves the above-described part-of-speech tagging for example, the preprocessing is realized by BLSTM (Bi-directional Long Short-Term Memory).

Expression 1 above obtains an optimal solution (value) of the objective function of the problem addressed by dynamic programming, and Expression 2 above obtains the argument (Y*) of an objective function that gives the optimal solution. In Expression 1, the optimal solution (value) is obtained by solving the objective function of the problem addressed by dynamic programming. On the other hand, in Expression 2, the argument (Y*) of the objective function is obtained by performing backtracking after the optimal solution (Value) has been obtained.

Whether the optimal solution (value) of the objective function is needed or the argument (Y*) of the objective function that gives the optimal solution is needed depends on the problem addressed by dynamic programming. For example, in the case of a problem that involves part-of-speech tagging or a problem that involves the alignment of pieces of time-series data, the argument (Y*) of the objective function that gives the optimal solution is needed. Note that there are also cases where both the optimal solution (value) of the objective function and the argument (Y*) of the objective function that gives the optimal solution are needed.

In general, in the case of obtaining the structured output data Y from the structured input data X, the procedure of Expression 2 is performed to obtain the argument (Y*) of the objective function that gives the optimal solution. At this time, structured output data Y=Y*. However, in the case of obtaining some sort of value when the structured output data Y=Y* has been obtained from the structured input data X (e.g., obtaining the accuracy of part-of-speech tagging when Y* has been obtained), the procedure of Expression 1 is performed to obtain the solution (value) of the objective function.

Also, in general, the optimal solution (value) of the objective function of the problem addressed by dynamic programming is often called the “dynamic programming solution”, but the argument (Y*) of the objective function that gives the optimal solution is also sometimes called the “dynamic programming solution”. In the embodiments of the present invention, the optimal solution (value) of the objective function of the problem addressed by dynamic programming will be called the “dynamic programming solution”.

Here, assuming that θ has been obtained through the above-described preprocessing, the processing for obtaining the optimal solution (value) of the objective function of the problem addressed by dynamic programming can be formulated into a problem of finding the path having the highest predetermined score among paths from the start node to the end node in a weighted directed acyclic graph (DAG).

Here, the weighted directed acyclic graph is expressed as G=(ν,ε), where ν is a set of nodes and ε is a set of edges. Also, let the number of nodes N be N=|ν|≥2. The edges in the set of edges ε are directed edges, and in the case of a directed edge from one node to another node, the one node is the “parent node”, and the other node is the “child node”.

Without loss of generality, the nodes can be ordered by sequentially giving numbers (IDs) to the nodes such that each node has a smaller number than its child node. Let the node with the ID 1 be the start node, and the node with the ID N be the end node. This can be expressed as follows.

V=[N] [symbol] {1, . . . ,N} [Formula 5]

Hereinafter, the node with the ID n will be indicated as “node n”. Note that “equals sign with a triangle above” means that the left-hand side of that sign is defined by the right-hand side.

In the weighted directed acyclic graph G, node 1 is the only node that does not have a parent node, and node N is the only node that does not have a child node. Also, in the weighted directed acyclic graph G, the directed edge (i,j) from the parent node j to the child node i has the weight θ_{i,j}∈R.

Let θ∈Θ⊆R^{N×N} be a matrix whose elements are the weights θ_{i,j} in the weighted directed acyclic graph G. Note that the weight θ_{i,j} for a directed edge (i,j) not included in the set of edges ε is θ_{i,j}=−∞.

Let the following be the set of all paths from node 1 to node N in the weighted directed acyclic graph G.

y′ [Formula 6]

The following arbitrary path

Y′∈y′ [Formula 7]

can be expressed as the binary matrix N×N. Specifically, letting be the element of the component (i,j), a path Y′ is a matrix of the element y′ᵢⱼ where y′ᵢⱼ=1 if the path Y′ passes through the directed edge (i,j), and y′ᵢⱼ=0 if the path Y′ does not pass through. The path Y′ expressed as such is in one-to-one correspondence with the structured output data Y. Accordingly, hereinafter, the path Y′ will be regarded the same as the structured output data Y, and will be indicated as “path Y” (yᵢⱼ being the element of the component (i,j) of the path Y). Similarly, a set of paths Y will be regarded the same as a set of the structured output data Y.

Here, letting <Y,θ> be the Frobenius inner product of Y and θ, <Y,θ> corresponds to the sum of the weights θ_{i,j} of the edges (i,j) along the path Y. Accordingly, letting the Frobenius inner product <Y,θ> be the score, the following combinational problem LP(θ) is solved to obtain the path Y=Y* having the highest score out of all of the paths Y.

$$LP ( θ ) {=}^{Δ} {max}_{Y ∈ y} 〈 Y , θ 〉 ∈ R . \qquad [ Formula 8 ]$$

Here, the magnitude of

y [Formula 9]

increases exponentially with N, but, using dynamic programming, LP(θ) can be calculated for an ordered path Y in the weighted directed acyclic graph G. In view of this, let the following be a set of parent nodes of the node i in the weighted directed acyclic graph G.

Pᵢ [Formula 10]

Then vᵢ(θ) is recursively defined by Expression 3 below.

$$\begin{matrix}[ Formula 11 ] & \\ {ν}_{1} ( θ ) {=}^{Δ} 0 \\ {∀}_{i} ∈ [ 2 , ⋯ , N ] : {v}_{i} ( θ ) {=}^{Δ} {max}_{j ∈ {𝒫}_{i}} {θ}_{i , j} + {ν}_{j} ( θ ) & ( 3 )\end{matrix}$$

Accordingly, the ultimately calculated v_{N}(θ) is DP(θ). In other words, DP(θ) is expressed as follows.

DP(θ) [symbol] v_{N}(θ) [Formula 12]

Because it can be proven that the solution calculated through dynamic programming is optimal, DP(θ)=LP(θ) is true for any θ∈Θ. In other words, the dynamic programming solution (“value” in Expression 1 above) can be obtained by calculating recursively-defined Expression 3 above.

Here, when the dynamic programming solution (optimal solution of the objective function) is obtained as shown in Expression 2, the problem of obtaining the argument (Y*) of the objective function that gives the optimal solution can be said to be the problem of obtaining the following for the path Y that gives the highest score.

$$\begin{matrix}[ Formula 13 ] & \\ {Y}^{*} ( θ ) ∈ {argmax}_{Y ∈ y} 〈 Y , θ 〉 & ( 4 )\end{matrix}$$

The argument (Y*) shown in Expression 4 above can be obtained by first performing the recursive calculation of Expression 3, and then performing backtracking.

However, DP(θ) is non-differentiable, and Y*(θ) is a discontinuous function. For this reason, if the dynamic programming computation is realized as a layer in a neural network, a derivative (derivative of a predetermined loss function) cannot be calculated through back propagation or the like, and therefore neural network training cannot be performed using gradient descent or the like.

In view of this, in these embodiments of the present invention, the procedures shown in Expressions 1′ and 2′ below are used in place of the procedures shown in Expressions 1 and 2.

$$\begin{matrix}[ Formula 14 ] & \\ X ∈ x {\to }_{preprocessing} θ ∈ Θ {\to }_{{DP}_{Ω}} value ∈ R \to … & ( {1}^{′} ) \\ [ Formula 15 ] & \\ X ∈ x {\to }_{preprocessing} θ ∈ Θ {\to }_{▽ {DP}_{Ω}} gradient ∈ conv ( y ) \to … & ( {2}^{′} )\end{matrix}$$

Here, DP_{Ω} is an approximation of DP, and the processing following DP_{Ω} (i.e., the processing in a layer following the dynamic programming computation layer in the neural network) can also be accurately defined similarly to the case of using DP. Also, ∇DP_{Ω} is the gradient of DP_{Ω}, and the following is true.

conv(y) is a convex hull of y [Formula 16]

This convex hull is defined as follows.

conv(y) [symbol] {Σ_{Y∈y}λ_{Y}Y: λ∈Δ^{|y|}} [Formula 17]

Also, Δ^{D} is a D-dimensional simplex, and is defined as follows.

Δ^{D} [symbol] {λ∈R₊^{D}∥λ∥₁=1} [Formula 18]

Here, unlike DP and Y*, DP_{Ω} and ∇DP_{Ω} are differentiable. Also, letting γ be arbitrary precision (in other words, letting γ be the difference between DP_{Ω} and DP), the relationship between DP_{Ω} and DP and the relationship between ∇DP_{Ω} and Y* are expressed as follows.

$${DP}_{γΩ} {\to }_{γ \to 0} DP \\ ▽ {DP}_{γΩ} {\to }_{γ \to 0} {Y}^{*} \qquad [ Formula 19 ]$$

In order to handle the dynamic programming problem using procedures approximated by Expressions 1′ and 2′, consider replacing the max function with the max_{Ω} function defined as follows.

$${max}_{Ω} ( x ) {=}^{Δ} {max}_{q ∈ {Δ}^{D}} 〈 q , x 〉 - Ω ( q ) \qquad [ Formula 20 ]$$

Here, Ω:Δ^{D}→R is a strongly-convex regularization function.

Also, as the max_{Ω} function regarding the following:

f:y→R [Formula 21]

the following notation is implemented for the sake of convenience.

$${{max}_{Ω}}_{Y ∈ y} f ( Y ) {=}^{Δ} {max}_{Ω} ( {( f ( Y ) )}_{Y ∈ y} ) \qquad [ Formula 22 ]$$

By then substituting the max function for Expression 3, Expression 5 below can be defined recursively.

$$\begin{matrix}[ Formula 23 ] & \\ {v}_{1} ( θ ) {=}^{Δ} 0 & ( 5 ) \\ {∀}_{i} ∈ [ 2 , … , N ] \text{:} {v}_{i} ( θ ) {=}^{Δ} {{max}_{Ω}}_{j ∈ {𝒫}_{i}} {θ}_{i , j} + {v}_{j} ( θ ) & \end{matrix}$$

Hereinafter, Expression 5 will also be expressed as follows for the sake of convenience.

(vᵢ(θ))ᵢ₌₁^{N} [Formula 24]

v_{N}(θ) ultimately calculated by Expression 5 is DP_{Ω}(θ). In other words, DP_{Ω}(θ) is expressed as follows.

DP_{ω}(θ) [symbol] v_{N}(θ) [Formula 25]

Accordingly, the dynamic programming computation layer can be expressed by the following two layers (Value layer and Gradient layer).

Value layer: DP_{Ω}(θ)∈R

Gradient layer: ∇DP_{Ω}(θ)∈conv(y) [Formula 26]

Note that when a dynamic programming solution is to be obtained, it is sufficient to use the Value layer as the neural network layer. On the other hand, when the value of the argument of the objective function that gives the dynamic programming solution is to be obtained, it is sufficient to use the Gradient layer as the neural network layer.

DP_{Ω}(θ) in the Value layer can be used as a differentiable approximation of DP(θ). For example, DP_{Ω}(θ) can be used when defining a loss function (let this loss function be L₁) that indicates how close a correct answer output Yₜᵣᵤₑ and a prediction output ∇DP_{Ω}(θ) of the neural network are to each other in neural network training. The loss function L₁ is defined by Expression 6 below, for example.

[Formula 27]

DP_{Ω}(θ)− [symbol] Yₜᵣᵤₑ,θ [symbol] ∈R (6)

The smaller the value of the loss function L₁ is, the closer the obtained prediction output ∇DP_{Ω}(θ) is to the correct answer output Yₜᵣᵤₑ.

When using the Value layer (i.e, the layer for calculating DP_{Ω}(θ)) as a layer in a neural network, the gradient ∇DP_{Ω}(θ) of DP_{Ω}(θ) needs to be calculated in order to train the parameters of the neural network. The gradient ∇DP_{Ω}(θ) can be calculated through back propagation using Expression 5. More specifically, letting E=∇DP_{Ω}(θ)∈R^{N×N}, Q=(qᵢⱼ)∈R^{N×N}, and h=(h₁, . . . , h_{N})∈R^{N}, then E=∇DP_{Ω}(θ)∈R^{N×N} can be obtained using the procedures from Step 1-1 to Step 1-3 described below. Note that it is assumed that θ∈R^{N×N} is given.

Step 1-1: As an initialization procedure, the following is set: v₁←0∈R, h_{N}←1∈R, Q←0∈R^{N×N}, E←0∈R^{N×N}. Note that “←” means substituting the right-hand side for the left-hand side.

Step 1-2: As a forward procedure, the following calculations and substitutions are performed sequentially for i=2, . . . , N.

$$\begin{matrix}{v}_{i} ← {{max}_{Ω}}_{j ∈ {𝒫}_{i}} {θ}_{i , j} + {v}_{j} & [ Formula 28 ] \\ {( {q}_{i , j} )}_{j ∈ {𝒫}_{i}} ← ∇ {{max}_{Ω}}_{j ∈ {𝒫}_{i}} {θ}_{i , j} + {v}_{j} & \end{matrix}$$

Step 1-3: As a backward procedure, the following calculations and substitutions are performed sequentially for j=N−1, . . . , 1.

$${∀}_{i} ∈ {C}_{j} , {e}_{i , j} ← {q}_{i , j} {h}_{i} , {h}_{j} ← {\sum }_{i ∈ {C}_{j}} {e}_{i , j} \qquad [ Formula 29 ]$$

Here, Cⱼ represents a set of child nodes of node J.

E, which is ultimately obtained by the above procedures, is ∇DP_{Ω}(θ).

On the other hand, the Gradient layer ∇DP_{Ω}(θ) can be used as a differentiable approximation of Y*(θ) defined by Expression 4. For example, ∇DP_{Ω}(θ) can be used when defining a loss function (let this loss function be L₂) that indicates how close a correct answer output Yₜᵣᵤₑ and a prediction output □DP_{Ω}(θ) of the neural net are to each other in neural network training. The loss function L₂ is defined by Expression 7 below, for example.

[Formula 30]

Δ(Yₜᵣᵤₑ,∇DP_{Ω}(θ)) (7)

Here, Δ is a divergence such as a Euclidean distance or a Kullback-Leibler divergence. The smaller the value of the loss function L₂ is, the closer the obtained prediction output ∇DP_{Ω}(θ) is to the correct answer output Yₜᵣᵤₑ.

In the case of using the Gradient layer (i.e., the layer for calculating ∇DP_{Ω}(θ)) as a layer in a neural network, in order to train the parameters of the neural network, it is necessary to calculate the product of the Jacobian ∇∇DP_{Ω}(θ) of ∇DP_{Ω}(θ) (i.e., the Hessian ∇²DP_{Ω}(θ)) and a given matrix Z∈R^{N×N}. This can be calculated by Pearlmutter's method disclosed in Reference Literature 1 below.
[Reference Literature 1] Pearlmutter, Barak A. Fast exact multiplication by the Hessian. Neural computation, 6(1):147-160, 1994.

Note that the Gradient layer ∇DP_{Ω}(θ) can also be used as a neural network attention mechanism.

Here, it is sufficient that the max_{Ω} function used in DP_{Ω}(θ) and ∇DP_{Ω}(θ) is appropriately set according to the problem addressed by dynamic programming, and the following are two specific examples of the max_{Ω} function.

### Example 1 of Max_{Ω} Function

Example 1 of the max_{Ω} function uses negative entropy as the strongly-convex regularization function Ω.

Take the following, where γ>0.

$$\begin{matrix}Ω ( q ) = - γ H ( q ) & [ Formula 31 ] \\ - H ( q ) = {\sum }_{i = 1}^{D} {q}_{i} log {q}_{i} ( negative entropy ) & \end{matrix}$$

Accordingly, the max_{Ω} function, the gradient ∇max_{Ω}, and the Hessian ∇²max_{Ω} are expressed as follows.

$${max}_{Ω} ( x ) = γlog ( {\sum }_{i = 1}^{D} exp ( {x}_{i} / γ ) ) \\ ∇ {max}_{Ω} ( x ) = exp ( x / γ ) / {\sum }_{i = 1}^{D} exp ( {x}_{i} / γ ) \\ {∇}^{2} {max}_{Ω} ( x ) = {J}_{Ω} ( ∇ {max}_{Ω} ( x ) ) \qquad [ Formula 32 ]$$

Now take the following.

J_{Ω}(q) [symbol] (Diag(q)−qq^{T})/γ [Formula 33]

Also, Diag(q) is square matrix given by elements having q as the diagonal component. Note that if γ=1, ∇max_{Ω} matches softmax.

### Example 2 of Max_{Ω} Function

Example 2 of the max_{Ω} function uses squared 2-norm as the strongly-convex regularization function Ω.

Take the following, where γ>0.

$$Ω ( x ) = \frac{γ}{2} {‖ x ‖}_{2}^{2} ( squared 2 - norm ) \qquad [ Formla 34 ]$$

Accordingly, the max_{Ω} function, the gradient ∇max_{Ω}, and the Hessian ∇²max_{Ω} are expressed as follows.

$$\begin{matrix}{max}_{Ω} ( x ) = 〈 {q}^{*} , x 〉 - \frac{γ}{2} {‖ {q}^{*} ‖}_{2}^{2} & [ Formula 35 ] \\ ∇ {max}_{Ω} ( x ) = {arg min}_{q ∈ {Δ}^{D}} {‖ q - x / γ ‖}_{2}^{2} = {q}^{*} \\ {∇}^{2} {max}_{Ω} ( x ) = {J}_{Ω} ( ∇ {max}_{Ω} ( x ) ) & \end{matrix}$$

Now take the following.

J_{Ω}(q) [symbol] (Diag(s)−ss^{T}/∥s∥₁)/γ [Formula 36]

Also, s∈{0,1}^{D} is a vector that supports the vector q. Note that ∇max_{Ω} is a Euclidean projection to a simplex.

∇max_{Ω} in Example 2 matches “sparsemax” described in Reference Literature 2 below. Accordingly, if the max_{Ω} function in Example 2 is used, it can be expected to obtain structured output data Y that has high sparsity.
[Reference Literature 2] Martins, Andre F. T. and Astudillo, Ramoon Fernandez. From softmax to sparsemax: A sparse model of attention and multi-label classification. In Proc. of ICML, pp. 1614-1623, 2016.

<Function Configuration>

The following describes the function configurations of the conversion device 100 and the training device 200 of embodiments of the present invention.

(Conversion Device 100)

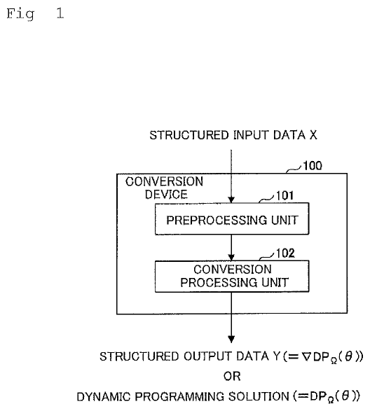

First, the function configuration of the conversion device 100 of this embodiment of the present invention will be described with reference to FIG. 1. FIG. 1 is a diagram showing an example of the function configuration of the conversion device 100 of this embodiment of the present invention.

As shown in FIG. 1, the conversion device 100 of this embodiment of the present invention includes a preprocessing unit 101 and a conversion processing unit 102. These function units are realized by the processing of one or more programs that are installed in the conversion device 100 and executed by an arithmetic device such as a CPU (Central Processing Unit).

The preprocessing unit 101 and the conversion processing unit 102 convert the structured input data X into the structured output data Y (=∇DP_{Ω}(θ)). Alternatively, the preprocessing unit 101 and the conversion processing unit 102 convert the structured input data X into a dynamic programming solution (=DP_{Ω}(θ)). Note that as previously mentioned, DP_{Ω}(θ) is more accurately an approximation of the dynamic programming solution DP(θ).

The preprocessing unit 101 and the conversion processing unit 102 are realized by one or more neural networks. For example, as previously mentioned, the preprocessing unit 101 is realized by a neural network such as a BLSTM, and the conversion processing unit 102 is realized by a neural network that has a dynamic programming computation layer.

Note that the preprocessing unit 101 and the conversion processing unit 102 may be realized by a neural network that is a combination of a neural network that realizes the preprocessing unit 101 and a neural network that realizes the conversion processing unit 102. In this case, the neural network that realizes the preprocessing unit 101 and the conversion processing unit 102 has a layer for converting the structured input data X into θ (a layer for performing the computation of the preprocessing unit 101), and a layer for converting θ into the structured output data Y (=∇DP_{Ω}(θ) or a dynamic programming solution (=DP_{Ω}(θ)) (a layer for performing the computation of the conversion processing unit 102).

The preprocessing unit 101 performs the preprocessing in Expression 1′ or 2′ using a trained neural network. Specifically, the preprocessing unit 101 converts the structured input data X into θ. This preprocessing is predetermined preprocessing that is determined according to the problem addressed by dynamic programming. For example, as previously mentioned, if the problem addressed by dynamic programming is part-of-speech tagging, the preprocessing is realized by BLSTM.

Note that instead of the conversion device 100 including the preprocessing unit 101, a device different from the conversion device 100 may include the preprocessing unit 101. In this case, it is sufficient that the structured input data X is converted into θ by the preprocessing unit 101 in the other device, and then 8 is input to the conversion device 100.

The conversion processing unit 102 performs computation corresponding to DP_{Ω} or ∇DP_{Ω} in Expression 1′ or 2′ using a trained neural network. Specifically, the conversion processing unit 102 converts θ, which was obtained by the preprocessing performed by the preprocessing unit 101, into the structured output data Y (=∇DP_{Ω}(θ)) or the dynamic programming solution (=DP_{Ω}(θ)). The conversion result (DP_{Ω}(θ) or ∇DP_{Ω}(θ)) is then output to a predetermined output destination. Examples of the predetermined output destination include a display device such as a display, a storage device such as an auxiliary storage device, another program, another device, or the next layer in the neural network.

In the case of performing computation corresponding to DP_{Ω}, it is sufficient that the conversion processing unit 102 performs the recursively-defined computation in Expression 5. Accordingly, DP_{Ω}(θ)=v_{N}(θ) is obtained.

However, in the case of performing computation corresponding to ∇DP_{Ω}, it is sufficient that the conversion processing unit 102 performs the computation shown in the procedures of Step 1-1 to Step 1-3. Accordingly, ∇DP_{Ω}(θ) is obtained.

Note that as described above, whether DP_{Ω}(θ) or ∇DP_{Ω}(θ) is to be obtained as the conversion result of the conversion processing unit 102 is determined according to the problem addressed by dynamic programming. Note that both DP_{Ω}(θ) and ∇DP_{Ω}(θ) may be obtained as conversion results of the conversion processing unit 102.

(Training Device 200)

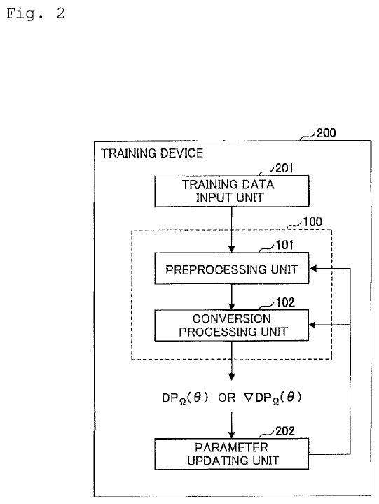

Next, the function configuration of the training device 200 of this embodiment of the present invention will be described with reference to FIG. 2. FIG. 2 is a diagram showing an example of the function configuration of the training device 200 of this embodiment of the present invention.

As shown in FIG. 2, the training device 200 of this embodiment of the present invention includes a training data input unit 201, a preprocessing unit 101, a conversion processing unit 102, and a parameter updating unit 202. These function units are realized by the processing of one or more programs that are installed in the training device 200 and executed by an arithmetic device such as a CPU.

Note that the preprocessing unit 101 and the conversion processing unit 102 of the training device 200 are similar to the preprocessing unit 101 and the conversion processing unit 102 of the conversion device 100 described above. However, predetermined initial values or the like have been set as the parameters of the neural networks that realize the preprocessing unit 101 and the conversion processing unit 102 of the training device 200. These parameters are updated through training.

The training data input unit 201 receives a training data set. The training data set is a set of training data made up of sets of structured input data Xₜᵣₐᵢₙ for use in training and correct answer output Yₜᵣᵤₑ that corresponds to the structured input data Xₜᵣₐᵢₙ.

The preprocessing unit 101 and the conversion processing unit 102 perform preprocessing and conversion processing (computation corresponding to DP_{Ω} or computation corresponding to ∇DP_{Ω}) on the pieces of structured input data Xₜᵣₐᵢₙ included in the training data received by the training data input unit 201, and DP_{Ω}(θ) or ∇DP_{Ω}(θ) is calculated as a conversion result.

The parameter updating unit 202 calculates the derivative of a predetermined loss function based on the conversion result DP_{Ω}(θ) or ∇DP_{Ω}(θ) obtained by the conversion processing unit 102 and the correct answer output Yₜᵣᵤₑ that corresponds to the structured input data X train subjected to preprocessing and conversion processing, and updates the parameters of the neural network using the calculated result. The derivative of the loss function is calculated using back propagation, for example. Also, the loss function is Expression 6 if the conversion result obtained by the conversion processing unit 102 is DP_{Ω}(θ), but is Expression 7 if the conversion result obtained by the conversion processing unit 102 is ∇DP_{Ω}(θ).

At this time, the parameter updating unit 202 repeatedly updates the parameters of the neural network until a predetermined condition is satisfied. This predetermined condition is for determining whether or not convergence has been obtained in the training of the neural network, and examples of the condition include whether or not the value of the loss function is less than or equal to a predetermined threshold value, and whether or not a predetermined repetition count has been reached.

If the predetermined condition has been satisfied, the parameter updating unit 202 outputs the values of the parameters of the neural network, for example, and then ends the processing.

### Example 1 of Operations of Conversion Device 100

As Example 1 of operations of the conversion device 100, the following describes the case where the conversion processing unit 102 performs calculation corresponding to the Viterbi algorithm. The Viterbi algorithm is one of the most famous examples of an algorithm used in dynamic programming, and is an algorithm for finding, as an output sequence, the most likely sequence of states among sequences of states for an input sequence in a state transition model of transitions from one state to another state with a predetermined probability at certain times. Letting the states be nodes, the transitions from one state to another state be directed edges, and the probabilities of transitions from one state to another state be weights, the state transition model can be expressed as a weighted directed acyclic graph (DAG). In this case, the sequences of states can be expressed as paths from the start node to the end node in the weighted directed acyclic graph.

Accordingly, letting the structured input data X be the input sequence X=(x₁, x₂, . . . , x_{T}), the Viterbi algorithm finds, as the solution (output sequence), the most likely sequence of states y (i.e., the mostly likely path y in the directed acyclic graph) among the sequences of states y=(y₁, y₂, . . . , y_{T}) for the input sequence X, for example. Here, each xₜ (t=1, 2, . . . , T) is a D-dimensional real vector, and each yₜ (t=1, 2, . . . , T) is an element of [S]. Note that [S] expresses the set {1, . . . , S}.

As a specific example, consider the case where the input sequence X is a word sequence X in which each xₜ is a word, and the output sequence y is a sequence of tags yₜ corresponding to xₜ. In this case, the Viterbi algorithm can be thought to be processing for performing part-of-speech tagging on the input sequence X.

Here, letting y_{t,i,j}=1 indicate the case of a transition from node j to node i at the time t, and y_{t,i,j}=0 indicate the case otherwise, a sequence of states y can be expressed as a binary tensor Y of T×S×S whose element of the (t,i,j) component is y_{t,i,j}.

Also, let θ_{t,i,j} be the probability of a transition from node j to node i at the time t, and let θ be the real tensor of T×S×S whose element of the (t,i,j) component is θ_{t,i,j}. This θ is obtained by the preprocessing unit 101 with use of BLSTM, for example. In other words, in this case, the preprocessing unit 101 of the conversion device 100 obtains the real tensor θ of T×S×S with use of BLSTM, for example.

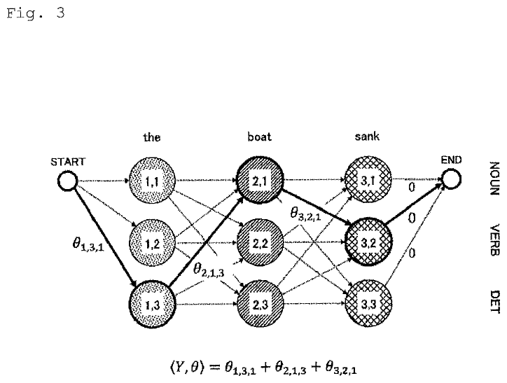

Accordingly, the Frobenius inner product <Y,θ> corresponds to the sum of the weights θ_{t,i,j} of the edges along the path expressed by the sequence of states y. This is shown in FIG. 3. In the example shown in FIG. 3 the input sequence is X=(x₁,x₂,x₃)=(the,boat,sank), the sequence of states is y=(y₁,y₂,y₃), and yₜ∈{NOUN,VERB,DET}, and in this case, the sequences of states y for the input sequence X include sequences of states y for transitions from node 1 to node 3 at the time t=1, from node 3 to node 1 at the time t=2, and from the node 3 to the node 2 at the time t=3. At this time, as shown in FIG. 3, the Frobenius inner product <Y,θ> is expressed as <Y,θ>=θ_{1,3,1}+θ_{2,1,3}+θ_{3,2,1}.

Here, if this Frobenius inner product <Y, θ>=θ_{1,3,1}+θ_{2,1,3}+θ_{3,2,1} has the highest score, the path y shown in FIG. 3 is the most likely path (i.e., the output sequence that is solution of the Viterbi algorithm), and that path y expresses that the part-of-speech y₁=“DET” (determiner) is associated with the word x₁=“the”, the part-of-speech y₂=“NOUN” is associated with the word x₂=“boat”, and the part-of-speech y₃=“VERB” is associated with the word x₃=“sank”.

Note that if Ω=−H (negative entropy), the linear-chain CRFs (Conditional Random Fields) disclosed in Reference Literature 3 below can be reconstructed.
[Reference Literature 3] Lafferty, John, McCallum, Andrew, and Pereira, Fernando C N. Conditional random fields: Probabilistic models for segmenting and labeling sequence data. In Proc. of ICML, pp. 282-289, 2001.

In order to obtain the solution of the Viterbi algorithm, the conversion processing unit 102 of the conversion device 100 need only calculate Vit_{Ω}(θ) defined below and ∇Vit_{Ω}(θ) calculated from Vit_{Ω}(θ), based on the real tensor θ of T×S×S obtained by the preprocessing unit 101.

Vit_{Ω}(θ) [symbol] max_{Ω}(v_{T}(θ)) [Formula 37]

Here, vₜ(θ)(t=1, . . . , T) is vₜ(θ)=(v_{t,1}(θ), . . . , v_{t,S}(θ)). Also, the i-th element v_{t,i}(θ) of vₜ(θ) is defined as follows.

$${v}_{t , i} ( θ ) {=}^{Δ} {{max}_{Ω}}_{j ∈ [ S ]} {v}_{t - 1 , j} ( θ ) + {θ}_{t , i , j} = {max}_{Ω} ( {ν}_{t - 1} ( θ ) + {θ}_{t , i} ) \qquad [ Formula 38 ]$$

Note that Vit_{Ω}(θ) is a convex function of an arbitrary Ω.

Here, Vit_{Ω}(θ) can be calculated through the procedures of Step 2-1 to Step 2-3 below (forward procedures). Also, ∇Vit_{Ω}(θ) can be calculated by performing the procedures of Step 3-1 and Step 3-2 below (backward procedures) after the procedures of Step 2-1 to Step 2-3 below have been performed. Note that in Step 2-1 to Step 2-3 and in Step 3-1 and Step 3-2 below, Q is a tensor of (T+1)×T×S, and U is a matrix of (T+1)×S, as shown below.

Q [symbol] (q)_{t=1,i,j=1}^{T+1,S,S},U [symbol] (u)_{t=1,j=1}^{T+1,S} [Formula 39]

Also, it is assumed that θ∈R^{T×N×N} is given.

Step 2-1: Let v₀=0∈R^{S}.

Step 2-2: For t=1, . . . , T, successively perform the following calculation for each i∈[S].

v_{t,i}=max_{Ω}(θ_{t,i}+vₜ₋₁)

q_{t,i}=∇max_{Ω}(θ_{t,i}+vₜ₋₁) [Formula 40]

Step 2-3: Calculate max_{Ω}(v_{T}) using v_{T}=(v_{T,1}, . . . , v_{T,S}) obtained above. This max_{Ω}(v_{T}) is Vit_{Ω}(θ). Also, assume the following for later-described Step 3-1 to Step 3-3.

v_{T+1,1}=max_{Ω}(v_{T})

q_{T+1,1}=∇max_{Ω}(v_{T}) [Formula 41]

Step 3-1: Let u_{T+1}=(1, 0, . . . , 0)∈R^{S}.

Step 3-2: For t=T, . . . , 0, successively perform the following calculation for each j∈[S].

e_{t,⋅,j}=q_{t+1,⋅,j}∘uₜ₊₁

u_{t,j}= [symbol] e_{t,⋅,j},1_{S} [symbol] [Formula 42]

Here, ∘ represents an element-wise product (Hadamard product).

The following is obtained through the above procedures.

$$∇ {Vit}_{Ω} ( θ ) = {( {e}_{t - 1 , i , j} )}_{t = 1 , i , j = 1}^{T , S , S} \qquad [ Formula 43 ]$$

Also, after the procedures of Step 3-1 to Step 3-3 have been performed, the procedures of Step 4-1 to Step 4-5 below can be used to calculate <∇Vit_{Ω}(θ),Z> and ∇²Vit_{Ω}(θ)Z for the given Z∈R^{T×S×S}. Note that the procedures of Step 4-1 to Step 4-3 are forward procedures, and the procedures of Step 4-4 and Step 4-5 are backward procedures.

Step 4-1: First, assume the following.

\dot{v}₀=0_{S} [Formula 44]

Step 4-2: For t=1, . . . , T, successively perform the following calculation for each i∈[S].

\dot{v}_{t,i}= [symbol] q_{t,i},z_{t,i}+\dot{v}ₜ₋₁

[symbol]

\dot{q}_{t,i}=J_{Ω}(q_{t,i})(zₜ+\dot{v}ₜ₋₁) [Formula 45]

Step 4-3: Calculate the following.

\dot{v}_{T+1,1}= [symbol] q_{T+1,1},\dot{v}_{T}

[symbol]

\dot{q}_{T+1,1}=J_{Ω}(\dot{q}_{T+1,1})\dot{v}_{T} [Formula 46]

Step 4-4: Next, assume the following.

\dot{u}_{T+1}=0_{S}

\dot{Q}_{T+1}=0_{S×S} [Formula 47]

Step 4-5: For t=T, . . . , 0, successively perform the following calculation for each i∈[S].

ė_{t,⋅,j}=q_{t+1,⋅,j}∘uₜ₊₁+\dot{q}_{t+1,⋅,j}∘\dot{u}ₜ₊₁

\dot{u}_{t,j}= [symbol] ė_{t,⋅,j},1_{S} [symbol] [Formula 48]

The following is obtained through the above procedures.

$$〈 V i {t}_{Ω} ( θ ) , Z 〉 = {\dot{ν}}_{T + 1} \\ {∇}^{2} V i {t}_{Ω} ( θ ) Z = {( {\dot{e}}_{t - 1 , i , j} )}_{t = 1 , i , j = 1}^{T , S , S} \qquad [ Formula 49 ]$$

### Example 2 of Operations of Conversion Device 100

As Example 2 of operations of the conversion device 100, the following describes the case where the conversion processing unit 102 performs calculation corresponding to DTW (Dynamic Time Warping). Dynamic time warping is used when analyzing the correlation (similarity) between two sequences of time-series data.

Let N_{A} be the sequence length of time-series data A, and N_{B} be the sequence length of time-series data B. Also, let aᵢ be the i-th observed value in the time-series data A, and bⱼ be the j-th observed value in the time-series data B.

Letting yᵢⱼ=1 indicate the case where aᵢ and bⱼ are similar to each other, and yᵢⱼ=0 indicate the case otherwise, when considering a binary matrix Y of N_{A}×N_{B} having yᵢⱼ as elements, the binary matrix Y is an alignment Y expressing the correspondence relationship (similarly relationship) between the time-series data A and the time-series data B.

Also, let θ be a matrix of N_{A}×N_{B}, and the elements of θ be θ_{i,j}. As a classical example, a differentiable distance scale d is used such that θ_{i,j}=d(aᵢ,bⱼ). This θ is obtained by the preprocessing unit 101 of the conversion device 100. Note that θ will also be called the distance matrix.

Accordingly, letting sets (aᵢ,bⱼ) of observed values be the nodes, the alignment Y expresses a path in a weighted directed acyclic graph (DAG).

Here, the following is the set of all monotone alignment matrices.

y [Formula 50]

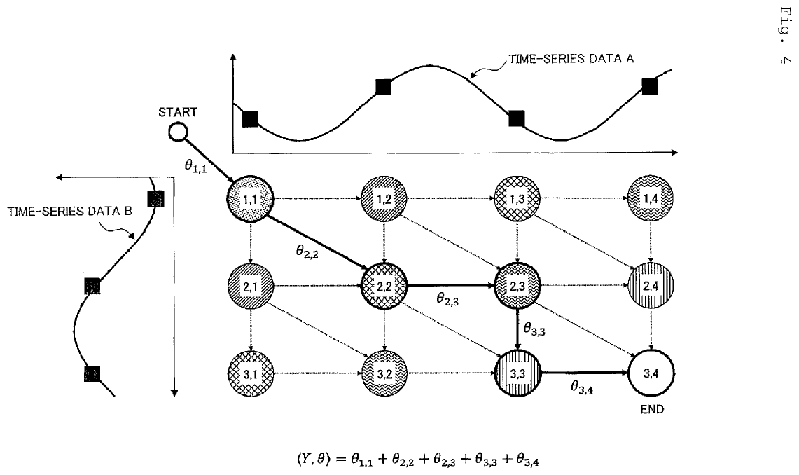

A monotone alignment matrix is a matrix in which the only path that is allowed is a non-backtracking path from an upper left (1,1) component to a lower right (N_{A},N_{B}) component in the matrix, that is to say, a path from the (i,j) node to either a rightward, leftward, or lower-right component. In other words, if yᵢⱼ=1, at least any one of y_{i+1,j}, y_{i,j+1}, and y_{i+1,j+1} is 1. FIG. 4 shows a path expressed by a monotone alignment matrix Y in the case where N_{A}=4 and N_{B}=3. The path shown in FIG. 4 is for the case where a₁ and b₁ are similar, a₂ and b₂ are similar, a₃ and b₂ are similar, and a₄ and b₃ are similar. In other words, the monotone alignment matrix Y in this case is expressed by a matrix in which y₁₁, y₂₂, y₃₂, and y₄₃ are all 1, and the other elements are 0.

Due to using the monotone alignment matrix Y, the Frobenius inner product <Y,θ> corresponds to the sum of the weights θ_{i,j} of the edges along the path shown by the monotone alignment matrix Y. In other words, the Frobenius inner product <Y,θ> can be used in the alignment cost. In the case of the path shown in FIG. 4, the Frobenius inner product <Y,θ> is expressed as <Y,θ>=θ_{1,1}+θ_{2,2}+θ_{2,3}+θ_{3,3}+θ_{3,4}.

Here, letting v_{i,j}(θ) be the cost of the (i,j) component (cell) of the alignment, v_{i,j}(θ) can be expressed as follows.

vᵢⱼ(θ)=θ_{i,j}+min_{Ω}(v_{i,j-1}(θ),v_{i-1,j-1}(θ),v_{i-1,j}(θ)) [Formula 51]

Also, the min_{Ω} function, the gradient ∇min_{Ω}, and the Hessian ∇²min_{Ω} are defined and implemented as follows.

$$\begin{matrix}{min}_{Ω} ( x ) {=}^{Δ} - {max}_{Ω} ( - x ) \\ ∇ {min}_{Ω} ( x ) = ∇ {max}_{Ω} ( - x ) & [ Formula 52 ] \\ \begin{matrix}{∇}^{2} {min}_{Ω} ( x ) = - {∇}^{2} {max}_{Ω} ( - x ) \\ = - {J}_{Ω} ( ∇ {max}_{Ω} ( - x ) ) \\ = - {J}_{Ω} ( V {min}_{Ω} ( x ) )\end{matrix} & \end{matrix}$$

Accordingly, in order to obtain the most likely alignment Y, the conversion processing unit 102 of the conversion device 100 need only calculate the below-defined DTW_{Ω}(θ) and ∇DTW_{Ω}(θ) calculated from DTW_{Ω}(θ), based on the distance matrix θ of N_{A}×N_{B} obtained by the preprocessing unit 101.

DTW_{Ω}(θ) [symbol] v_{N}_{_{A}}_{,N}_{_{B}}(θ) [Formula 53]

Here, DTW_{Ω}(θ) can be calculated through the procedures of Step 5-1 and Step 5-2 below (forward procedures). Also, ∇DTW_{Ω}(θ) can be calculated through the procedures of Step 6-1 and Step 6-2 below (backward procedures). Note that in Step 5-1 and Step 5-2 and in Step 6-1 and Step 6-2 below, Q is a tensor of (N_{A}+1)×(N_{B}+1)×3, and E is a matrix of (N_{A}+1)×(N_{B}+1), as shown below.

Q [symbol] (q)_{i,j,k=1}^{N}^{_{A}}^{+1,N}^{_{B}}^{+1,3}

E [symbol] (e)_{i,j=1}^{N}^{_{A}}^{+1,N}^{_{B}}⁺¹ [Formula 54]

Also, assume that the following is given.

θ∈R^{N}^{_{A}}^{×N}^{_{B}} [Formula 55]

Step 5-1: Let v_{0,0}=0. Also, let v_{i,0}=v_{0,j}=∞ for i=1, . . . , N_{A}, j=1, . . . , N_{B}.

Step 5-2: Successively perform the following calculation for i=1, . . . , N_{A}, j=1, . . . , N_{B}.

v_{i,j}=d_{i,j}+min_{Ω}(v_{i,j-1},v_{i-1,j-1},v_{i-1,j})

q_{i,j}=∇min_{Ω}(v_{i,j-1},v_{i-1,j-1},v_{i-1,j})∈R³ [Formula 56]

Step 6-1: Next, assume the following for i=1, . . . , N_{A}, j=1, . . . , N_{B}.

q_{i,N}_{_{B}}₊₁=q_{N}_{_{A}}_{+1,j}=0₃

e_{i,N}_{_{B}}₊₁=e_{N}_{_{A}}_{+1,j}=0

g_{N}_{_{A}}_{+1,N}_{_{B}}₊₁=(0,1,0)

e_{N}_{_{A}}_{+1,N}_{_{B}}₊₁=1 [Formula 57]

Step 6-2: Successively perform the following calculation for j=N_{B}, . . . , 1, i=N_{A}, . . . , 1.

e_{i,j}=q_{i,j+1,1}e_{i,j+1}+q_{i+1,j+1,2}e_{i+1,j+1}+q_{i+1,j,3}e_{i+1,j} [Formula 58]

The following is obtained through the above procedures.

DTW_{Ω}(θ)=v_{N}_{_{A}}_{,N}_{_{B}}

∇DTW_{Ω}(θ)=(e)_{i,j=1}^{N}^{_{A}}^{,N}^{_{B}} [Formula 59]

Also, after the procedures of Step 5-1 and Step 5-2 have been performed, the procedures of Step 7-1 to Step 7-4 below can be used to calculate <∇DTW_{Ω}(θ),Z> and ∇²DTW_{Ω}(θ)Z for the given following.

Z∈R^{N}^{_{A}}^{×N}^{_{B}} [Formula 60]

Note that the procedures of Step 7-1 and Step 7-2 are forward procedures, and the procedures of Step 7-3 and Step 7-4 are backward procedures.

Step 7-1: First, assume the following for i=0, . . . , N_{A}, j=1, . . . , N_{B}.

\dot{v}_{i,j}=\dot{v}_{0,j}=0 [Formula 61]

Step 7-2: Successively perform the following calculation for i=1, . . . , N_{B}, j=1, . . . , N_{A}.

\dot{v}_{i,j}=z_{i,j,1}\dot{v}_{i,j-1}+q_{i,j,2}\dot{v}_{i-1,j-1}+q_{i,j,3}\dot{v}_{i-1,j}

\dot{q}_{i,j}=−J_{Ω}(q_{i,j})(\dot{v}_{i,j-1},\dot{v}_{i-1,j-1},\dot{v}_{i-1,j})∈R³ [Formula 62]

Step 7-3: Next, assume the following for i=0, . . . , N_{A}, j=1, . . . , N_{B}.

\dot{q}_{i,N}_{_{B}}₊₁=\dot{q}_{N}_{_{A}}_{+1,j}=0₃

ė_{i,N}_{_{B}}₊₁=ė_{N}_{_{A}}_{+1,j}=0 [Formula 63]

Step 7-4: Successively perform the following calculation for j=N_{B}, . . . , 1, i=N_{A}, . . . , 1.

$$[ Formula 64 ]$$

$${\dot{e}}_{i , j} = {\dot{q}}_{i , j + 1 , 1} {e}_{i , j + 1} + {q}_{i , j + 1 , 1} {\dot{e}}_{i , j + 1} + {\dot{q}}_{i + 1 , j + 1 , 2} {e}_{i + 1 , j + 1} + {q}_{i + 1 , j + 1 , 2} {\dot{e}}_{i + 1 , j + 1} + {\dot{q}}_{i + 1 , j , 3} {e}_{i + 1 , j} + {q}_{i + 1 , 3} {\dot{e}}_{i + 1 , j}$$

The following is obtained through the above procedures.

[symbol]

∇DTW_{Ω}(θ),Z [symbol] =\dot{v}_{N}_{_{A}}_{,N}_{_{B}}

∇²DTW_{Ω}(θ)Z=(ė)_{i,j=1}^{N}^{_{A}}^{,N}^{_{B}} [Formula 65]

### Effects of Present Invention

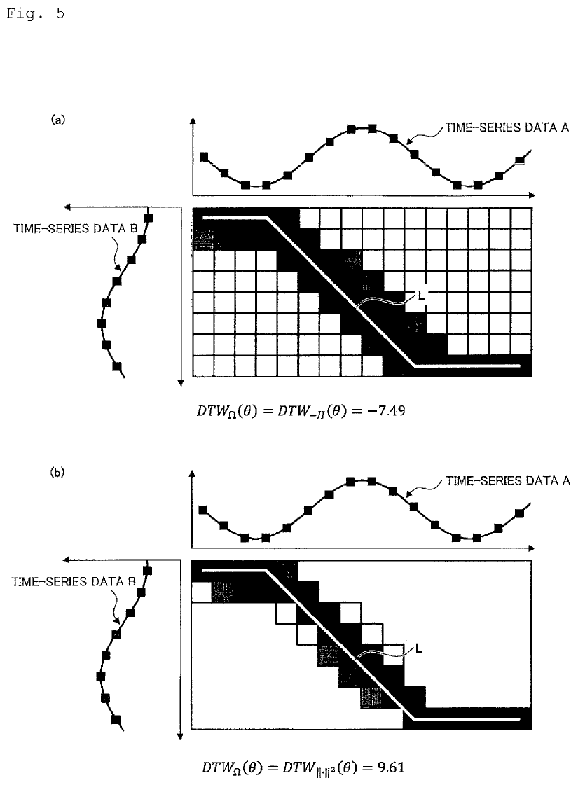

The following describes effects of the present invention by way of example of using Example 2, with reference to FIG. 5. FIG. 5 is a diagram showing an example of effects of the present invention.

In FIG. 5, (a) shows a heat map of DTW_{Ω}(θ)=−7.49 and ∇DTW_{Ω}(θ) in the case of using negative entropy as Ω. On the other hand, (b) of FIG. 5 shows a heat map of DTW_{Ω}(θ)=9.61 and ∇DTW_{Ω}(θ) in the case of using squared 2-norm as Ω. In these heat maps, the darker the color of a cell is, the higher the value is, and the absence of a cell indicates that the value is 0. Also, a line L in (a) and (b) of FIG. 5 does not indicate the max_{Ω} function, but rather indicates an alignment corresponding to DTW(θ) in the case of using the max function.

As shown in (a) and (b) of FIG. 5, all ∇DTW_{Ω}(θ) can approximate the alignment corresponding to DTW(θ) with high precision, and it is understood that high interpretability has been obtained. Also, in FIG. 5, higher sparsity has been obtained in (b) than in (a). Accordingly, it can be understood that with the embodiments of the present invention, it is possible to realize dynamic programming computation that is differentiable and has high interpretability.

Note that ∇DTW_{Ω}(θ) shown as a heat map in (a) and (b) in FIG. 5 is obtained through back propagation, as previously described. Accordingly, distance matrix θ training can be performed.

<Hardware Configuration>

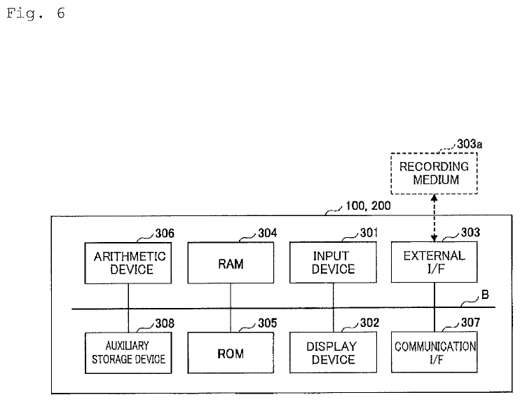

Lastly, a hardware configuration of the conversion device 100 and the training device 200 of embodiments of the present invention will be described with reference to FIG. 6. FIG. 6 is a diagram showing an example of a hardware configuration of the conversion device 100 and the training device 200 of embodiments of the present invention. Note that the conversion device 100 and the training device 200 can be realized with similar hardware configurations, and therefore the following mainly describes the hardware configuration of the conversion device 100.

As shown in FIG. 6, the conversion device 100 of this embodiment of the present invention includes an input device 301, a display device 302, an external I/F 303, a RAM (Random Access Memory) 304, a ROM (Read Only Memory) 305, an arithmetic device 306, a communication I/F 307, and an auxiliary storage device 308. These pieces of hardware are connected to each other and can communicate with each other via a bus B.

The input device 301 is a keyboard, a mouse, a touch panel, or the like, and is used for the input of various operations by a user. The display device 302 is a display or the like, and displays processing results of the conversion device 100. Note that at least either the input device 301 or the display device 302 may be omitted from the conversion device 100 and the training device 200.

The external I/F 303 is an interface with an external apparatus. One example of the external apparatus is a recording medium 303a. The conversion device 100 can read data from and write data to the recording medium 303a or the like via the external I/F 303. The recording medium 303a may have recorded thereon one or more programs for realizing the function units of the conversion device 100 or the function units of the training device 200, for example.

Examples of the recording medium 303a include a flexible disk, a CD (Compact Disc), a DVD (Digital Versatile Disk), an SD memory card (Secure Digital memory card), and a USB (Universal Serial Bus) memory card.

The RAM 304 is a volatile semiconductor memory for temporarily holding programs and data. The ROM 305 is a non-volatile semiconductor memory that can hold programs and data even if the power is cut. The ROM 305 has stored therein settings for an OS (Operating System), settings for a communication network, and the like.

The arithmetic device 306 is a CPU, a GPU (Graphics Processing Unit), or the like, and is for reading out programs and data from the ROM 305 and the auxiliary storage device 308 to the RAM 304 and executing processing.

The communication I/F 307 is an interface for connecting the conversion device 100 to a communication network. One or more programs for realizing the function units of the conversion device 100 or the function units of the training device 200 may be acquired (downloaded) by a predetermined server device or the like via the communication I/F 307.

The auxiliary storage device 308 is a non-volatile storage device such as an HDD (Hard Disk Drive) or an SSD (Solid State Drive), and stores programs and data. The programs and data stored in the auxiliary storage device 308 include an OS and one or more programs for realizing the function units of the conversion device 100 or the function units of the training device 200.

The conversion device 100 and the training device 200 of embodiments of the present invention can realize the various types of processing described above due to having the hardware configuration shown in FIG. 6.

The present invention is not intended to be limited to the embodiments that have been disclosed in detail above, and various modifications and changes can be made without departing from the scope of the claims.

### REFERENCE SIGNS LIST

100 Conversion device
101 Preprocessing unit
102 Conversion processing unit
200 Training device
201 Training data input unit
202 Parameter updating unit

1. A conversion device that converts input first data X into second data Y using a neural network, the conversion device comprising:
a processor; and
a memory storing program instructions that cause the processor to calculate an approximation DP_{Ω}(θ) of a solution of dynamic programming that addresses a problem expressed by a weighted directed acyclic graph G, with use of third data θ obtained by predetermined preprocessing performed on the first data X, and with use of a DP_{Ω} function recursively defined using a max_{Ω} function in which a strongly-convex regularization function Ω is implemented in a max function, and output, as the second data Y, at least one of the calculated approximation DP_{Ω}(θ) and a gradient ∇DP_{Ω}(θ) of the calculated approximation DP_{Ω}(θ).

2. The conversion device according to claim 1, wherein letting the max_{Ω} function be defined as
$${max}_{Ω} ( x ) {=}^{Δ} {max}_{q ∈ {Δ}^{D}} 〈 q , x 〉 - Ω ( q )$$
and letting vᵢ(θ) be recursively defined as follows for i=1, . . . , N
$${v}_{1} ( θ ) {=}^{Δ} 0$$
$${v}_{i} ( θ ) {=}^{Δ} {{max}_{Ω}}_{j ∈ {𝒫}_{i}} {θ}_{i , j} + {v}_{j} ( θ )$$
Here, Pᵢ represents a set of parent nodes of node i in G
the DP_{Ω} function is defined as DP_{Ω}(θ)=v_{N}(θ).

3. The conversion device according to claim 1, wherein the strongly-convex regularization function Ω is one of
$$Ω ( q ) = - γ H ( q ) \\ - H ( q ) = {\sum }_{i = 1}^{D} {q}_{i} log {q}_{i}$$
$$and$$
$$Ω ( q ) = \frac{γ}{2} {‖ q ‖}_{2}^{2}$$
where γ>0.

4. A training device that trains a neural network for converting input first data X into second data Y, the training device comprising:
a processor; and
a memory storing program instructions that cause the processor to calculate an approximation DP_{Ω}(θ) of a solution of dynamic programming that addresses a problem expressed by a weighted directed acyclic graph G, with use of third data θ obtained by predetermined preprocessing performed on the first data X, and with use of a DP_{Ω} function recursively defined using a max_{Ω} function in which a strongly-convex regularization function Ω is implemented in a max function, output, as the second data Y, at least one of the calculated approximation DP_{Ω}(θ) and a gradient ∇DP_{Ω}(θ) of the calculated approximation DP_{Ω}(θ), and update the third data θ based on a derivative of a loss function that uses the output approximation DP_{Ω}(θ) or the output gradient ∇DP_{Ω}(θ) and correct answer data Yₜᵣᵤₑ for the first data X, the third data θ being a parameter of the neural network.

5. The training device according to claim 4, wherein if the approximation DP_{Ω}(θ) is output, the loss function is DP_{Ω}(θ)−<Yₜᵣᵤₑ,θ>, and if the gradient ∇DP_{Ω}(θ) is output, the loss function is divergence Δ(Yₜᵣᵤₑ,∇DP_{Ω}(θ)).

6. A conversion method performed by a computer that converts input first data X into second data Y using a neural network, the conversion method comprising:
calculating an approximation DP_{Ω}(θ) of a solution of dynamic programming that addresses a problem expressed by a weighted directed acyclic graph G, with use of third data θ obtained by predetermined preprocessing performed on the first data X, and with use of a DP_{Ω} function recursively defined using a max_{Ω} function in which a strongly-convex regularization function Ω is implemented in a max function; and
outputting, as the second data Y, at least one of the calculated approximation DP_{Ω}(θ) and a gradient ∇DP_{Ω}(θ) of the calculated approximation DP_{Ω}(θ).

7. (canceled)

8. A non-transitory computer-readable recording medium having stored therein a program comprising the program instructions for causing a computer to function as the conversion device according to claim 1.
